(19) United States
(12) Patent Application Publication
(10) Pub. No.: US 2026/0261087 A1
(43) Pub. Date: Sep. 3, 2026

(54) MODULAR CONNECTION SYSTEMS AND METHODS FOR ELECTRICAL DEVICES

(71) Applicant: Toyota Motor Engineering & Manufacturing North America, Inc., Plano, TX (US)

(72) Inventors: Billy J. Davis, Ypsilanti, MI (US); Luke A. Rippelmeyer, Plano, TX (US); Carl A. Wixon, Ann Arbor, MI (US)

(73) Assignees: Toyota Motor Engineering & Manufacturing North America, Inc., Plano, TX (US); Toyota Jidosha Kabushiki Kaisha, Toyota-shi, Aichi-ken (JP)

(21) Appl. No.: 19/067,057

(22) Filed: Feb. 28, 2025

(51) Int. Cl. H01R 31/06; H01R 13/502; H01R 43/20

(52) U.S. Cl. CPC H01R 31/06; H01R 13/502; H01R 43/20

(57) ABSTRACT

Methods, systems, and apparatus for an electrical connector adapter. The electrical connector adapter can include mating bus bars, a housing, and a connector interface. The housing can include a plurality of openings (e.g., a first opening disposed in a first wall including an outwardly facing surface facing a first direction, a second opening disposed in a second wall including a second outwardly facing surface facing a second direction, and a third opening disposed in a third wall including a third outwardly facing surface facing a third direction). The bus bars can from within the housing through the first opening. The connector interface can be selectively coupled to the housing at either one of the second opening or the third opening as desired depending on the desired orientation.

### BACKGROUND

### Field

The present disclosure relates generally to the field of electrical circuits and related apparatus and, more particularly, to apparatus and methods useful in making electrical connections.

### Description of the Related Art

Conventional electronic devices typically include a housing containing an electrical circuit. Electrical connectors are mounted to the electronic device for connecting external components to the electrical circuit. High voltage electrical wires typically are stiff and heavy. These high voltage wires can be difficult to route as they have low flexibility and large bending radii. The orientation of the electrical connector is often limited by the geometry of the housing at the location of the opening. In order to change the orientation of the electrical connector, the housing is typically redesigned for desired electrical connector orientation. Redesign of the housing can affect the operation or location of adjacent electronic device components and/or be costly.

Accordingly, it is desirable to provide systems, methods, and techniques for electrical connectors that allow desired routing of stiff, high voltage electrical wires.

### SUMMARY

One aspect of the subject matter described in this disclosure may be embodied in an electrical connector adapter for an electronic device. The electrical connector adapter can include a housing defining an internal volume, a first outwardly facing surface, and a second outwardly facing surface. A first opening can be disposed in the first outwardly facing surface. The housing can be configured to be coupled to the electronic device at the first outwardly facing surface. A second opening can be disposed in the second outwardly facing surface. The housing can be configured to be coupled to a connector interface at the second outwardly facing surface. The electrical connector adapter can further include a pair of bus bars having first ends located within the internal volume and second ends located externally from the housing. The pair of bus bars can extend through the first outwardly facing surface.

In various aspects, the first outwardly facing surface faces a first direction and the second outwardly facing surface faces a second direction that is different from the first direction.

In various aspects, the first direction is oriented substantially perpendicular with respect to the second direction.

In various aspects, the electrical connector adapter further includes a housing cover opening disposed in the housing. In various aspects, the electrical connector adapter further includes a housing cover configured to be removably coupled to the housing at the housing cover opening.

In various aspects, the electrical connector adapter further includes a third outwardly facing surface. The third outwardly facing surface can face a third direction that is opposite the second direction. The housing cover can extend between and to the second outwardly facing surface and the third outwardly facing surface.

In various aspects, the electrical connector adapter further includes a third outwardly facing surface facing a third direction, a third opening disposed in the third outwardly facing surface, and a removable housing cover plate configured to be removably coupled to the housing at the third opening so as to cover the third opening. In various aspects, the housing is configured to be coupled to the connector interface at the third outwardly facing surface. In various aspects, each bus bar of the pair of bus bars includes a first portion extending along the first direction through the first opening and a second portion extending along a fourth direction through the internal volume. The fourth direction can be perpendicular to the first direction.

In various aspects, each bus bar of the pair of bus bars is L-shaped.

In another aspect, the subject matter may be embodied in an electrical connector adapter including a housing, a pair of bus bars, and a connector interface. The housing can have an internal volume, a first wall defining a first outwardly facing surface facing a first direction, a second wall defining a second outwardly facing surface facing a second direction, and a third wall defining a third outwardly facing surface facing a third direction. A first opening can be disposed in the first outwardly facing surface. The housing can be configured to be coupled to the electronic device at the first outwardly facing surface. A second opening can be disposed in the second outwardly facing surface. A third opening can be disposed in the third outwardly facing surface. The pair of bus bars can have first ends located within the internal volume and second ends located externally from the housing. The pair of bus bars can extend through the first outwardly facing surface. The connector interface can be configured to be selectively coupled to the housing at either one of the second opening of the second outwardly facing surface or the third opening of the third outwardly facing surface.

In various aspects, the electrical connector adapter further includes a removable housing cover plate configured to be removably coupled to the housing at the third opening so as to cover the third opening.

In various aspects, the electrical connector adapter further includes a housing cover opening disposed in the housing, and a housing cover configured to be removably coupled to the housing at the housing cover opening. In various aspects, the housing cover opening extends between and to the second wall and the third wall. In various aspects, the second wall extends between and to the housing cover opening and the first wall. In various aspects, the third wall extends between and to the housing cover opening and the first wall.

In various aspects, each bus bar of the pair of bus bars includes a first portion extending through the first opening and a second portion extending substantially perpendicular to the first portion within the internal volume. The first portion can include a first tab disposed at the first end of the respective bus bar that extends toward the second opening for coupling to the connector interface when the connector interface is installed at the second opening. The first portion can further include a second tab disposed at the first end of the bus bar that extends toward the third opening for coupling to the connector interface when the connector interface is installed at the third opening. In various aspects, the first tab is offset from the second tab.

In various aspects, the connector interface includes a pair of terminals configured to be electronically coupled to the pair of bus bars. In various aspects, the electrical connector adapter further includes a gasket configured to circumscribe at least one of the first opening, the second opening, or the third opening.

In another aspect, the subject matter may be embodied in a method for manufacturing an electrical connector adapter. The method can include coupling a pair of bus bars to a housing. The housing can define an internal volume, a first wall defining a first outwardly facing surface facing a first direction, a second wall defining a second outwardly facing surface facing a second direction, and a third wall defining a third outwardly facing surface facing a third direction. The pair of bus bars can include first ends located within the internal volume and second ends located externally from the housing. The pair of bus bars can extend through the first outwardly facing surface. The housing can include a first opening disposed in the first outwardly facing surface, a second opening disposed in the second outwardly facing surface, and a third opening disposed in the third outwardly facing surface. The housing can be configured to be coupled to an electronic device at the first outwardly facing surface. The method can further include coupling a connector interface to the housing at the second opening of the second outwardly facing surface. The method can further include coupling a housing cover plate to the housing at the third opening of the third outwardly facing surface.

In various aspects, the method further includes coupling a housing cover to the housing at a housing cover opening disposed in the housing.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale and may be exaggerated to better illustrate the important features of the present invention.

FIG. 1 is a perspective view of an electrical connector adapter installed on an electronic device, according to an aspect of the invention.

FIG. 2A is a perspective front view of an electrical connector adapter with a front housing cover removed, according to an aspect of the invention.

FIG. 2B is a perspective rear view of the electrical connector adapter of FIG. 2A, according to an aspect of the invention.

FIG. 2C is an assembly view of the electrical connector adapter of FIG. 2A, according to an aspect of the invention.

### DETAILED DESCRIPTION

Disclosed herein are systems, methods, devices, and/or vehicles for implementing an electrical connector adapter for an electronic device. Various aspects of an electrical connector adapter include mating bus bars, a housing, and a connector interface of the designer's choice. The housing can include a plurality of openings (e.g., a first opening, a second opening, and a third opening). The electrical connector adapter can include a pair of bus bars disposed at least partially within the housing and having ends that extend through the first opening. The electrical connector adapter can be connected to an electrical device at the first opening. The connector interface can be selectively coupled to the second opening or the third opening depending on a desired orientation of the connector interface whereby an electrical connector/high voltage wiring can be connected to the electrical connector adapter.

Various aspects of an electrical connector adapter can provide freedom to use one electrical device across several applications, thus standardizing the cost and design. Various aspects of an electrical connector adapter can allow the assembly to be optimized for each application of a single modular device; giving more opportunity to reduce parts and development costs by increasing the applicable environments to use a single standard core device. Various aspects adapt a connector interface position on an electrical device housing to facilitate usage of a modular electrical device which can be used on several unique product designs. The “adaptor” attaches to the existing components in the part, allowing for seamless integration.

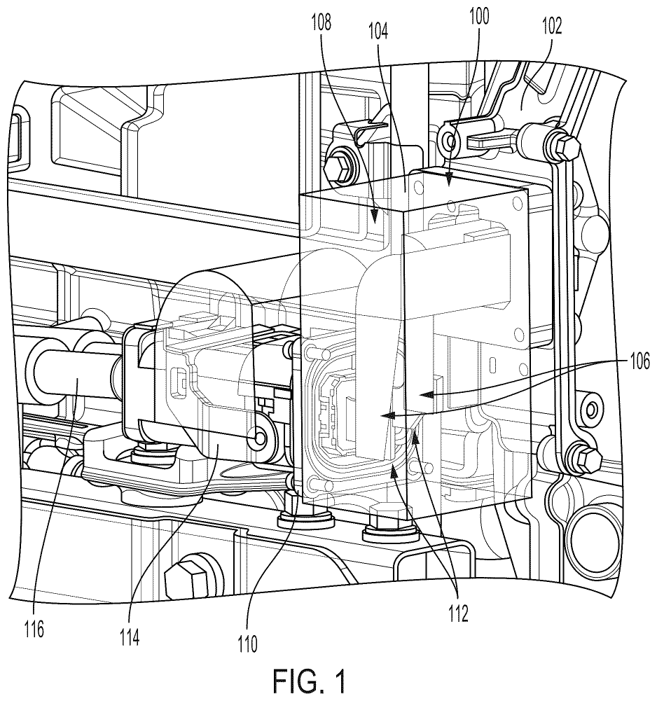

FIG. 1 shows a perspective view of an electrical connector adapter 100 installed on an electronic device 102, in accordance with various aspects. The electrical connector adapter 100 can be a two-pole adapter. The electrical connector adapter 100 can be a high voltage adapter. For example, the electrical connector adapter 100 can be configured to handle voltages that are greater than 120V in various aspects, greater than 240V in various aspects, or greater than 480V in various aspects. The electrical connector adapter 100 can be rated for 1000V DC in various aspects. The electrical connector adapter 100 can generally include a housing 104 and a pair of bus bars 106. The housing 104 is transparent in FIG. 1 for clarity purposes. The pair of bus bars 106 can include a first bus bar 106 electrically isolated from a second bus bar 106. The housing 104 can define an internal volume 108. The bus bars 106 can be disposed at least partially within the internal volume 108 of the housing 104. The housing 104 can be connected to the electronic device 102. The bus bars 106 can be electrically coupled with the electronic device 102. When the electrical connector adapter 100 is installed on the electronic device 102, the bus bars 106 can extend at least partially into the electronic device 102. In this regard, the electrical connector adapter 100 can be disposed at an opening in the electronic device 102. The bus bars 106 can be configured to receive electrical power from corresponding bus bars or electrical terminals of the electronic device 102. The electronic device 102 can be a power source. In various aspects, the electronic device 102 is a power generator.

A connector interface 110 can be coupled to the housing 104. The connector interface 110 can include a pair of terminals 112 configured to electrically couple to the bus bars 106 so that electrical current can pass therebetween. The pair of terminals 112 can extend into the internal volume 108 of the housing 104. The connector interface 110 can be mounted to the housing 104 such that it is accessible from an exterior of the housing 104.

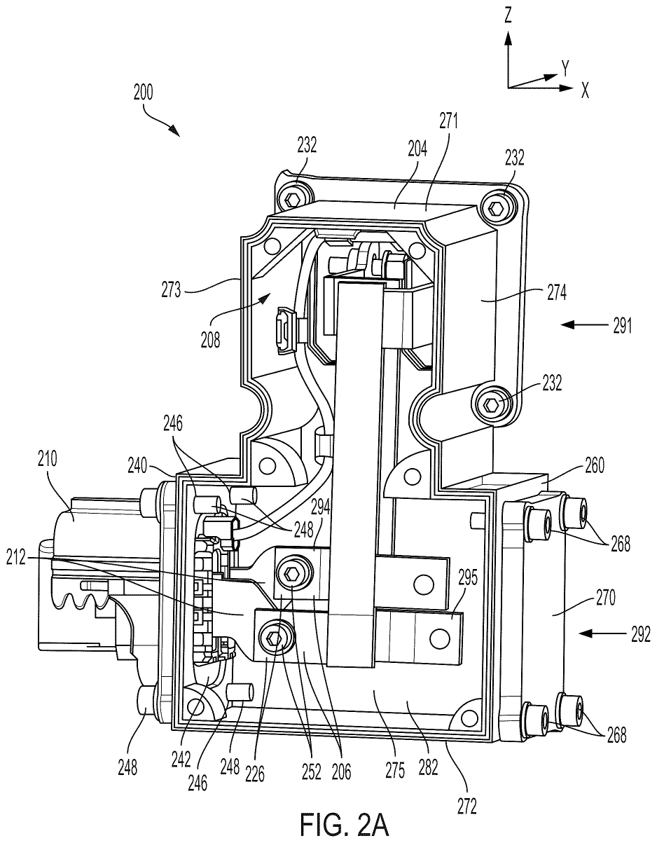

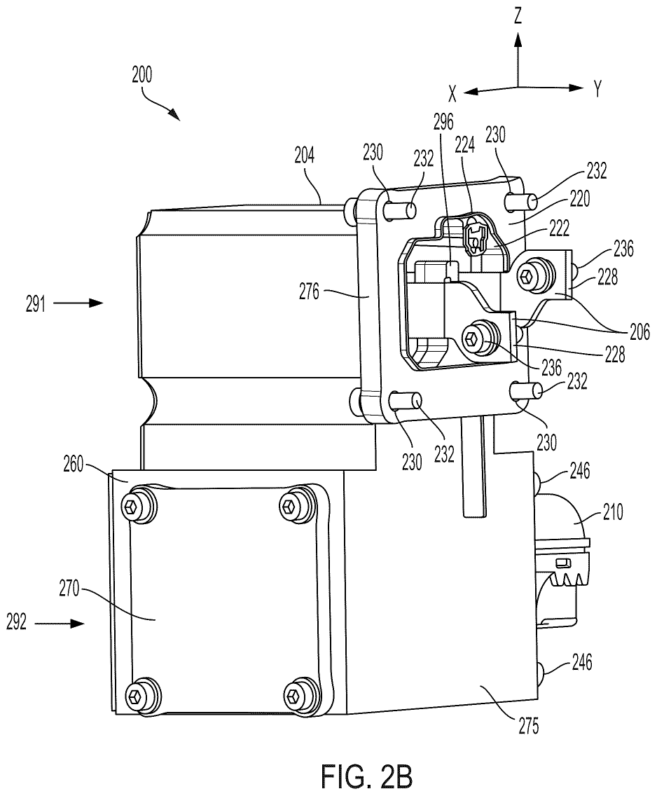

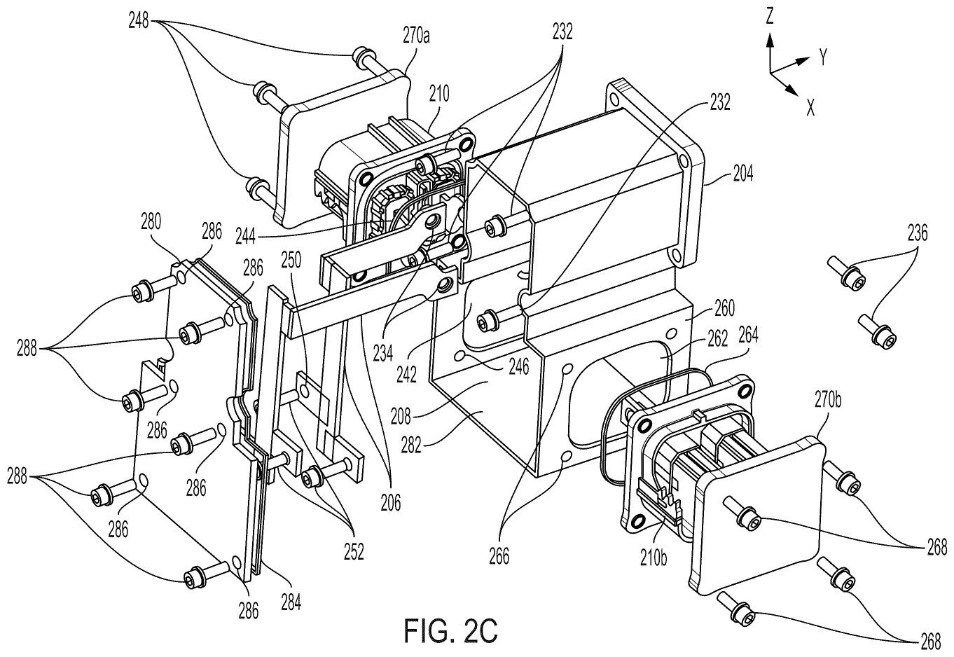

The connector interface 110 can be configured to receive an electrical connector 114. The electrical connector 114 can be a two-pole connector. The electrical connector 114 can be a high voltage connector. For example, the electrical connector 114 can be rated for at least 120V in various aspects, rated for at least 240V in various aspects, rated for at least 480V in various aspects, or rated for at least 1000V DC in various aspects. A pair of high voltage wires 116 can extend from the electrical connector 114. The wires 116 can have low flexibility and large bending radii. As described in greater detail with respect to FIG. 2A through FIG. 2C, the electrical connector adapter 100 can provide a modular adapter whereby the electrical connector 116 can be electrically coupled to the electronic device 102 in a desired orientation. In this regard, the electrical connector adapter 100 can be used in various designs or implementations to permit the electrical connector 116 to be oriented in a desired direction without interference with adjacent components and/or to reduce the overall footprint of the wiring.

FIG. 2A, FIG. 2B, and FIG. 2C are front perspective, side perspective, and assembly views of an example electrical connector adapter 200, in accordance with various aspects. In various aspects, the electrical connector adapter 200 can be similar to the electrical connector adapter 100 described with respect to FIG. 1. The electrical connector adapter 200 can generally include a housing 204 and a pair of bus bars 206. The housing 204 can define an internal volume 208. The bus bars 206 can be disposed at least partially within the internal volume 208 of the housing 204. In various aspects, the bus bars 206 can be L-shaped. The housing 204 can be connected to an electronic device (e.g., see electronic device 102 of FIG. 1).

The pair of bus bars 206 can have first ends 226 located within the internal volume 208. The pair of bus bars 206 can have second ends 228 located externally from the housing 204. The pair of bus bars 206 can extend through the first opening 222 of the first outwardly facing surface 220.

With particular focus on FIG. 2B, the housing 204 can define a first outwardly facing surface 220. A first opening 222 can be disposed in the first outwardly facing surface 220. The housing 204 can be configured to be coupled to an electronic device (e.g., see electronic device 102 of FIG. 1) at the first outwardly facing surface 220. In various aspects, the housing 204 includes a gasket 224 circumscribing the first opening 222 for sealing the first outwardly facing surface 220 to the electronic device. In this manner, the internal volume 208 can be protected from debris and/or moisture.

The first outwardly facing surface 220 can have a plurality of fastener apertures 230 disposed therein whereby the housing 204 is secured to an electronic device (e.g., see electronic device 102 of FIG. 1). A plurality of fasteners 232 (e.g., bolts, screws, or the like) can be used for fastening the housing 204 to the electronic device. The plurality of fastener apertures 230 can be sized and configured to receive the plurality of fasteners 232.

With particular focus on FIG. 2C, the second ends 228 of the bus bars 206 can each have a fastener aperture 234 configured to receive a fastener 236 (e.g., a bolt, a screw, or the like) for securing the bus bars 206 to corresponding electrical conductors in the electronic device whereby the bus bars 206 receive electrical power (i.e., a flow of electrical current).

With particular focus on FIG. 2A, the housing 204 can define a second outwardly facing surface 240. A second opening 242 can be disposed in the second outwardly facing surface 240. The housing 204 can be configured to be coupled to a connector interface 210 at the second opening 242. The connector interface 210 can be similar to the connector interface 110 of FIG. 1. The connector interface 210 can include a pair of terminals 212 configured to electrically couple to the bus bars 206 so that electrical current can pass therebetween. The pair of terminals 212 can extend into the internal volume 208 of the housing 204. The connector interface 210 can be mounted to the housing 204 such that it is accessible from an exterior of the housing 204.

In various aspects, with particular focus on FIG. 2C, the housing 204 includes a gasket 244 circumscribing the second opening 242 for sealing the second outwardly facing surface 240 to the electronic device. In this manner, the internal volume 208 can be protected from debris and/or moisture.

With reference again to FIG. 2A, the second outwardly facing surface 240 can have a plurality of fastener apertures 246 disposed therein whereby the connector interface 210 (or the or the removable housing cover plate 270a; see FIG. 2C) is secured to the housing 204. A plurality of fasteners 248 (e.g., bolts, screws, or the like) can be used for fastening the connector interface 210 to the housing 204. The plurality of fastener apertures 246 can be sized and configured to receive the plurality of fasteners 248.

The first ends 226 of the bus bars 206 can each have a fastener aperture 250 (see FIG. 2C) configured to receive a fastener 252 (e.g., a bolt, a screw, or the like) for securing the bus bars 206 to the terminals 212. The bus bars 206 can be made of a rigid material (e.g., a conductive metal or metal alloy). The bus bars 206 can be held in place with respect to the housing 204 at both ends via the connection with the connector interface 210 (e.g., see fasteners 252) and the connection with the electronic device (e.g., see fasteners 236).

The housing 204 can define a third outwardly facing surface 260. A third opening 262 can be disposed in the third outwardly facing surface 260. With particular focus on FIG. 2C, the housing 204 can be configured to be coupled to a connector interface 210b (referred to herein generally as a connector interface 210) at the third opening 262. In this regard, a connector interface 210 can be coupled to the housing 204 at the second opening 242 or the third opening 262 depending on the desired orientation of the connector interface 210. The first ends 226 of the bus bars 206 can each have a first portion (also referred to herein as a first tab 294) that extends toward the second opening 242 for connecting to a connector interface 210 connected at the second opening 242. The first ends 226 of the bus bars 206 can each have a second portion (also referred to herein as a second tab 295) that extends toward the third opening 262 for connecting to a connector interface 210 connected at the third opening 262. In this manner, the electrical connector adapter 200 can be modular such that the connector interface 210 can be mounted at different locations of the housing 204 in different orientations as desired.

In various aspects, the housing 204 includes a gasket 264 circumscribing the third opening 262 for sealing the third outwardly facing surface 260 to the connector interface 210 and/or a removable housing cover plate 270b (referred to generally herein as removable housing cover plate 270). In this manner, the internal volume 208 can be protected from debris and/or moisture.

The third outwardly facing surface 260 can have a plurality of fastener apertures 266 disposed therein whereby the connector interface 210 or the removable housing cover plate 270 is secured to the housing 204. A plurality of fasteners 268 (e.g., bolts, screws, or the like) can be used for fastening the connector interface 210 to the housing 204. The plurality of fastener apertures 266 can be sized and configured to receive the plurality of fasteners 268.

A removable housing cover plate 270a can be coupled to the second outwardly facing surface 240 when the connector interface 210 is omitted. The removable housing cover plate 270a can cover the second opening 242 when the second opening 242 is not being used for a connector interface.

A removable housing cover plate 270b can be coupled to the third outwardly facing surface 260 when the connector interface 210b is omitted. The removable housing cover plate 270b can cover the third opening 262 when the third opening 262 is not being used for a connector interface.

The housing 204 can define a fourth opening 282 (also referred to herein as a housing cover opening). With particular focus on FIG. 2C, the housing 204 can be configured to be coupled to a housing cover 280 at the third opening 262. The housing cover 280 can be removably coupled to the housing 204 at the fourth opening 282. The housing cover 280 can be formed as a flat plate. In the installed position, the housing cover 280 can extend between and to the second outwardly facing surface 240 and the third outwardly facing surface 260. The fourth opening 282 can provide access to the internal volume 208 of the housing 204, for example for connecting and/or disconnecting the bus bars 206 to/from the connector interface 210.

In various aspects, with particular focus on FIG. 2C, the housing 204 includes a gasket 284 circumscribing the fourth opening 282 for sealing the housing cover 280 to the housing 204. In this manner, the internal volume 208 can be protected from debris and/or moisture.

The housing cover 280 can have a plurality of fastener apertures 286 disposed therein whereby the housing cover 280 is secured to the housing 204. A plurality of fasteners 288 (e.g., bolts, screws, or the like) can be used for fastening the housing cover 280 to the housing 204. The plurality of fastener apertures 286 can be sized and configured to receive the plurality of fasteners 288.

The first outwardly facing surface 220 can face a first direction (i.e., the positive Y direction). The second outwardly facing surface 240 can face a second direction (i.e., the negative X direction). The third outwardly facing surface 260 can face a third direction (i.e., the positive X direction). The first direction is different from the second direction and the third direction. The third direction is different from the second direction. In various aspects, the third direction is opposite the second direction. In this regard, the second outwardly facing surface 240 and the third outwardly facing surface 260 can be located at opposing sides of the housing 204. In various aspects, the second direction is substantially perpendicular (e.g., between 80°-100°) to the first direction. In various aspects, the third direction is substantially perpendicular (e.g., between 80°-100°) to the first direction. The fourth opening 282 can face a fourth direction (i.e., the negative Y direction). The fourth direction can be opposite the first direction (i.e., the positive Y-direction). In various aspects, the housing 204 can be symmetrical about a central plane (i.e., the housing 204 can be mirrored about a plane in the Y-Z axis).

With reference to FIG. 2A, the housing 204 can extend vertically (i.e., along the Z-direction) between a top wall 271 and a bottom wall 272. The top wall 271 can extend laterally (i.e., along the X-direction) between and to a first sidewall 273 and a second sidewall 274. The bottom wall 272 can extend laterally (i.e., along the X-direction) between and to the first sidewall 273 and the second sidewall 274. The first sidewall 273 and/or the second sidewall 274 can extend longitudinally (i.e., along the Y-direction) between the fourth opening 282 and a back wall 275.

With reference to FIG. 2B, a flange 276 can extend from the back wall 275. The flange 276 can define the first outwardly facing surface 220. The first outwardly facing surface 220 can be offset from the back wall 275. Stated differently, the flange 276 can extend outwardly (i.e., in the positive Y-direction) from the back wall 275 such that the flange 276 protrudes from the back wall 275. In this manner, the back wall 275 can be spaced apart from the electronic device when the housing 204 is installed on the electronic device. The first opening 222 can extend through the flange 276. The first opening 222 can extend through the back wall 275.

The housing 204 can include a first portion 291 (e.g., an upper portion) and a second portion 292 (e.g., a lower portion). In various aspects, the first portion 291 includes a first half of the housing 204 and the second portion 292 includes a second half of the housing 204. The bus bars 206 can include a first portion that extends through the first opening 222 along the first direction (i.e., the Y-direction) at the first portion 291 of the housing. The bus bars 206 can include a second portion disposed within the internal cavity 208 that extends along a fourth direction (also referred to herein as the vertical direction; along the Z-direction) between the first portion 291 of the housing 204 and the second portion 292 of the housing 204. The second opening 242 and the third opening 262 can be disposed in the second portion 292 of the housing 204.

With combined reference to FIG. 2A and FIG. 2C, each bus bar 206 can include a first tab 294 disposed at the first end 226 of the bus bar 206 that extends toward the second opening 242 for coupling to a connector interface 210 when the connector interface 210 is installed at the second opening 242. Each bus bar 206 can include a second tab 295 disposed at the first end 226 of the bus bar 206 that extends toward the third opening 262 for coupling to a connector interface 210 when the connector interface 210 is installed at the third opening 262. The first tab 294 can be offset from the second tab 295 along the Z-direction. In this manner, the first and second tabs are more easily accessible through the fourth opening 282 (i.e., the tabs of the first bus bar 206 are not overlapping the tabs of the second bus bar 206 when viewed from the fourth opening 282 along the Y-direction).

In various aspects, a support post 296 can extend into the first opening 222. The support post 296 can be formed integrally (i.e., monolithically) with the housing 204. The support post 296 can be formed by a part of the back wall 275. The support post 296 can be disposed between the first bus bar 206 and the second bus bar 206. The support post 296 can separate the first bus bar 206 from the second bus bar 206 to prevent the first bus bar 206 from contacting the second bus bar 206.

The housing 204 and its components are described above using the terms “bottom” and “top” with reference to exemplary orientations in the drawings. The present disclosure, however, is not limited to any particular formation system orientations. For example, in various embodiments, the top wall 271 may alternatively be configured as a bottom wall and the bottom wall 272 may alternatively be configured as a top wall. In various embodiments, the top wall 271 may alternatively be configured as a side wall and the bottom wall 272 may alternatively be configured as a side wall. Moreover, the first side wall 273 and/or the second side wall 274 may alternatively be configured as a top wall or a bottom wall, in accordance with various embodiments.

Exemplary aspects of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such aspects that reasonably fall within the scope of the advancement to the art hereby contributed, and that that scope shall not be restricted, except in light of the appended claims and their equivalents.

Benefits, other advantages, and solutions to problems have been described herein with regard to specific aspects. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments,” “one embodiment,” “an embodiment,” “an example embodiment,” “various aspects,” “one aspect,” “an aspect,” “an example aspect,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is intended to invoke 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. An electrical connector adapter for an electronic device, the electrical connector adapter comprising:
a housing defining an internal volume, a first outwardly facing surface, and a second outwardly facing surface;
a first opening disposed in the first outwardly facing surface, the housing is configured to be coupled to the electronic device at the first outwardly facing surface;
a second opening disposed in the second outwardly facing surface, the housing is configured to be coupled to a connector interface at the second outwardly facing surface; and
a pair of bus bars having first ends located within the internal volume, second ends located externally from the housing, and the pair of bus bars extend through the first outwardly facing surface.

2. The electrical connector adapter of claim 1, wherein the first outwardly facing surface faces a first direction and the second outwardly facing surface faces a second direction that is different from the first direction.

3. The electrical connector adapter of claim 2, wherein the first direction is oriented substantially perpendicular with respect to the second direction.

4. The electrical connector adapter of claim 2, further comprising:
a housing cover opening disposed in the housing; and
a housing cover configured to be removably coupled to the housing at the housing cover opening.

5. The electrical connector adapter of claim 4, further comprising a third outwardly facing surface, the third outwardly facing surface faces a third direction that is opposite the second direction, and the housing cover extends between and to the second outwardly facing surface and the third outwardly facing surface.

6. The electrical connector adapter of claim 2, further comprising:
a third outwardly facing surface facing a third direction;
a third opening disposed in the third outwardly facing surface; and
a removable housing cover plate configured to be removably coupled to the housing at the third opening so as to cover the third opening.

7. The electrical connector adapter of claim 6, wherein the housing is configured to be coupled to the connector interface at the third outwardly facing surface.

8. The electrical connector adapter of claim 6, wherein each bus bar of the pair of bus bars includes a first portion extending along the first direction through the first opening and a second portion extending along a fourth direction through the internal volume, and the fourth direction is perpendicular to the first direction.

9. The electrical connector adapter of claim 8, wherein each bus bar of the pair of bus bars is L-shaped.

10. An electrical connector adapter for an electronic device, the electrical connector adapter comprising:
a housing defining an internal volume, a first wall defining a first outwardly facing surface facing a first direction, a second wall defining a second outwardly facing surface facing a second direction, and a third wall defining a third outwardly facing surface facing a third direction;
a first opening disposed in the first outwardly facing surface, the housing is configured to be coupled to the electronic device at the first outwardly facing surface;
a second opening disposed in the second outwardly facing surface;
a third opening disposed in the third outwardly facing surface;
a pair of bus bars having first ends located within the internal volume and second ends located externally from the housing, and the pair of bus bars extends through the first outwardly facing surface; and
a connector interface configured to be selectively coupled to the housing at either one of the second opening of the second outwardly facing surface or the third opening of the third outwardly facing surface.

11. The electrical connector adapter of claim 10, further comprising a removable housing cover plate configured to be removably coupled to the housing at the third opening so as to cover the third opening.

12. The electrical connector adapter of claim 10, further comprising:
a housing cover opening disposed in the housing; and
a housing cover configured to be removably coupled to the housing at the housing cover opening.

13. The electrical connector adapter of claim 12, wherein the housing cover opening extends between and to the second wall and the third wall.

14. The electrical connector adapter of claim 12, wherein the second wall extends between and to the housing cover opening and the first wall and the third wall extends between and to the housing cover opening and the first wall.

15. The electrical connector adapter of claim 10, wherein each bus bar of the pair of bus bars includes a first portion extending through the first opening and a second portion extending substantially perpendicular to the first portion within the internal volume, the first portion includes a first tab disposed at the first end of the respective bus bar that extends toward the second opening for coupling to the connector interface when the connector interface is installed at the second opening, and the first portion further includes a second tab disposed at the first end of the bus bar that extends toward the third opening for coupling to the connector interface when the connector interface is installed at the third opening.

16. The electrical connector adapter of claim 15, wherein the first tab is offset from the second tab.

17. The electrical connector adapter of claim 10, wherein the connector interface includes a pair of terminals configured to be electronically coupled to the pair of bus bars.

18. The electrical connector adapter of claim 10, further comprising a gasket configured to circumscribe at least one of the first opening, the second opening, or the third opening.

19. A method for manufacturing an electrical connector adapter, the method comprising:
coupling a pair of bus bars to a housing, wherein the housing defines an internal volume, a first wall defining a first outwardly facing surface facing a first direction, a second wall defining a second outwardly facing surface facing a second direction, and a third wall defining a third outwardly facing surface facing a third direction, wherein the pair of bus bars includes first ends located within the internal volume and second ends located externally from the housing, the pair of bus bars extends through the first outwardly facing surface, and the housing includes a first opening disposed in the first outwardly facing surface, a second opening disposed in the second outwardly facing surface, and a third opening disposed in the third outwardly facing surface, and the housing is configured to be coupled to an electronic device at the first outwardly facing surface;
coupling a connector interface to the housing at the second opening of the second outwardly facing surface; and
coupling a housing cover plate to the housing at the third opening of the third outwardly facing surface.

20. The method of claim 19, further comprising coupling a housing cover to the housing at a housing cover opening disposed in the housing.
